(19) United States
(12) Patent Application Publication
(10) Pub. No.: US 2005/0124708 A1
(43) Pub. Date: Jun. 9, 2005

(54) Syntactic foam

(76) Inventor: Ho Sung Kim, New South Wales (AU)

Correspondence Address: OSTROLENK FABER GERB & SOFFEN, 1180 AVENUE OF THE AMERICAS, NEW YORK, NY, 100368403, US

(21) Appl. No.: 10/506,458

(22) PCT Filed: Feb. 28, 2003
(86) PCT No.: PCT/AU03/00250

(30) Foreign Application Priority Data
Mar. 1, 2002 (AU) PS0855

(51) Int. Cl. C08J 9/00

(52) U.S. Cl. 521/50

(57) ABSTRACT

A low density syntactic foam comprising micro-spheres bound by a cured liquid phase binder is formed by allowing the micro-spheres (1) to rise to a close packed surface layer (4) in the liquid phase binder (2), and then draining excess liquid phase binder from the mould (3) before curing. The use of the buoyant force to achieve close packing of the micro-spheres is enhanced by controlling the viscous drag and curing time in the liquid phase binder (2) by selecting predetermined amounts of diluent, which is typically acetone in an epoxy resin binder.

The present invention relates to a method of manufacturing low density syntactic foam.

### BACKGROUND OF THE INVENTION

Syntactic foam is made up of a mix of pre-formed micro-spheres and a binder, typically an epoxy resin. Syntactic foams have been used in areas where low densities are required with high strength as in undersea/marine equipment for deep-ocean current metering, anti-submarine warfare and sandwich composites.

The process of manufacturing syntactic foams is different from that of conventional foams. In one known manufacturing process, the consolidation method for binder and micro-spheres includes the coating of micro-spheres, prior to which are the steps of vacuum filtering and rinsing. Other manufacturing processes make use of inorganic binder solution and firing, dry resin powder for sintering, and liquid resin as binder for in-situ reaction injection moulding.

A major difficulty is always to achieve a sufficiently low density. One manufacturing process for syntactic foam has been developed using a compaction method which includes a mixture of liquid resin/micro-spheres achieving a resin volume fraction of 0.09 and a density of 0.6 g/cc.

A slip casting method employing porous plaster moulds to drain excessive liquid binder has also been developed. An advantage of this method is its potentially suitability for the manufacture of thick items while the disadvantages could be the limited service life of the plaster mould and poor surface finish.

Any discussion of the prior art throughout the specification should in no way be considered as an admission that such prior art is widely known or forms part of common general knowledge in the field.

### DISCLOSURE OF THE INVENTION

According to the present invention there is provided a method of manufacturing syntactic foam including the steps of:
providing a predetermined ratio of constituent materials including a liquid phase binder and microspheres that are naturally buoyant in that binder;
blending the constituent materials into a mixture and placing the mixture into a mould;
allowing the microspheres to float to the top of the mixture;
draining excess liquid phase binder from the mould; and
allowing the remaining liquid phase binder to set or cure between the micro spheres.

Preferably the microspheres are allowed to float to the top of the mixture until they become close packed.

Preferably the microspheres become close packed in a density approaching the natural microsphere bulk density.

Preferably the step of allowing the microspheres to float to the top of the mixture until they become close packed is facilitated by selecting a liquid phase binder composition that has sufficiently low viscous drag characteristics, and sufficiently long curing time, to allow the microspheres to become close packed before the binder cures.

Preferably the liquid phase binder composition is selected by adding a predetermined amount of diluent.

Preferably the liquid phase binder includes an epoxy resin with hardener, and the diluent comprises acetone.

Preferably the excess liquid phase binder is drained from the bottom of the mould.

Preferably the liquid phase binder is drained until the close packed microspheres reach the bottom of the mould.

### BRIEF DESCRIPTION OF THE DRAWINGS

Not withstanding any other forms that may fall within its scope, one preferred embodiment of the invention will now be described, by way of example only, with reference to the accompanying drawings in which:

FIG. 1a) is a diagrammatic view of a mixture of micro-spheres and liquid phase binder immediately after being placed into a mould;

FIG. 1b) is a similar view to FIG. 1a) after a period of time such that the micro-spheres are partially packed due to the buoyancy of the micro-spheres in the liquid binder;

FIG. 1c) is a similar view to FIG. 1b) after a further period of time such that the micro-spheres are closely packed; and

FIG. 1d) is a similar view to FIG. 1c) after an additional further period showing the closely packed layer of micro-spheres gravitated down the mould after excess liquid phase binder is drained.

### PREFERRED EMBODIMENTS OF THE INVENTION

In the laboratory, a method of manufacturing syntactic foam typically includes the steps of, mixing a liquid phase binder by first placing a clean, empty mixing container on an electronic scale, adding a predetermined amount of acetone, and then injecting pre-mixed epoxy and hardener into the container using a plastic syringe until the required mass is reached. The container is closed and shaken vigorously for 2 minutes. The container is then opened and the micro-spheres added through a glass funnel. The container is then sealed and shaken again vigorously for a further 5 minutes to disperse the micro-spheres.

For subsequent casting, the container is kept shaken to maintain a consistent mixture ratio whilst the mixture is being poured through a tube into a mould.

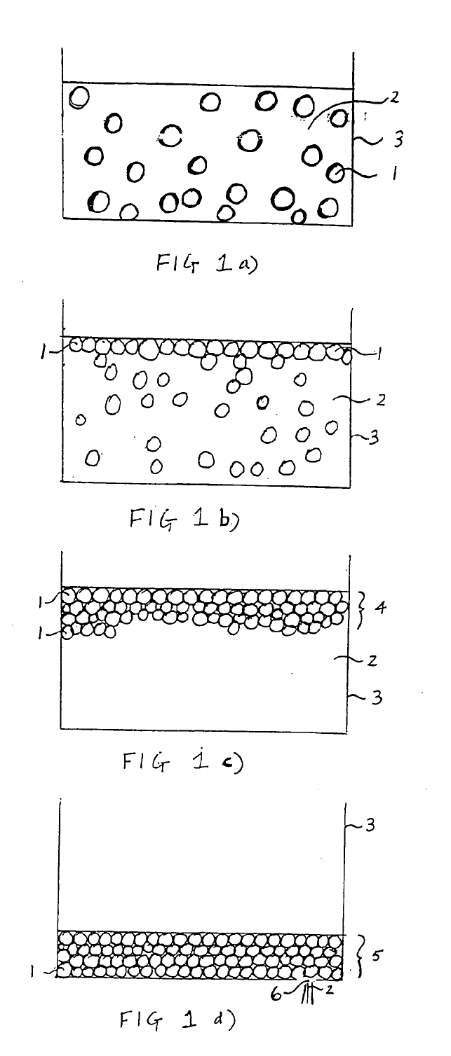

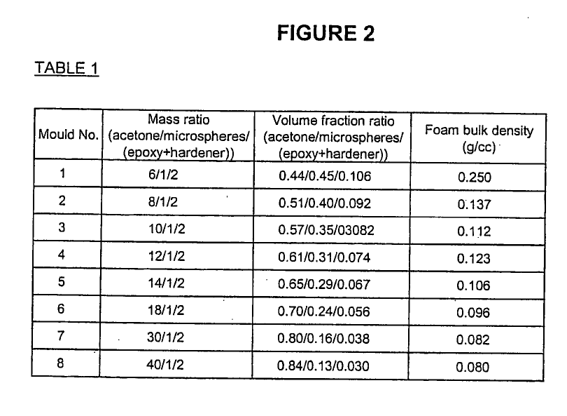

Referring to FIG. 1(a), a mixture of micro-spheres 1 and liquid phase binder 2 are placed into a mould 3 after thorough mixing such that the micro-spheres 1 are dispersed evenly within the liquid phase binder 2.

The micro-spheres are chosen to be naturally buoyant in the liquid phase binder and are typically whole hollow spheres. The ultimate performance of the syntactic foam can be improved by carefully selecting appropriate whole hollow micro-spheres and conducting the mixing process in a manner which reduces the number of broken spheres to a minimum.

The micro-spheres 1 which are initially in suspension with the liquid phase binder 2 as shown in FIG. 1(a) begin by the natural buoyancy effect to move to the upper surface of the mould as shown in FIG. 1(b).

Over time, the micro-spheres 1 begin to self-pack into a close packed layer 4 as shown in FIG. 1(c) by the natural effect of the buoyant force exerted on each micro-sphere immersed in the liquid phase binder 2.

Over time, the separation becomes more complete with the close packed micro-spheres clustered on the surface of the binder which can then be drained from the bottom of the mould through an opening 6 as shown in FIG. 1(d). The excess liquid phase binder is typically drained to the point where the close packed layer of micro-spheres touches the bottom of the mould forming a layer 5 at the bottom of the mould as can be clearly seen in FIG. 1(d).

The process can take different periods of time depending on the nature of the liquid phase binder, but typically after 30 minutes in a laboratory situation, the foam in the mould is sufficiently dry and the liquid phase binder cured so that the layer 5 can be de-moulded.

Although the process has been described in a laboratory situation, it will be apparent that it can be adapted to a production situation and that syntactic foams of different shapes and configurations can be made depending on the shape of the mould 3 and the amount of micro-spheres introduced in the original mixture.

To utilise the method according to the invention efficiently, it is important to select the characteristics of the liquid phase binder such that the micro-spheres have sufficient time to rise into the close packed layer 4 before the binder cures or thickens sufficiently that the viscous drag will inhibit the close packing of the micro-spheres. This is typically achieved by adding selected amounts of diluent to the binder. In the case of an epoxy resin binder, this diluent is typically acetone as described above.

The ratio of acetone to epoxy resin and hardener is important as adding too much acetone will not only significantly defer the curing time of the resin, but will also affect the buoyant force on the micro-spheres due to the lower density of the liquid phase binder. The effect of these ratios can be seen in the example given below.

Densities of manufactured syntactic foam with various amounts of constituent materials are listed in FIG. 2 Table 1. From Table 1, we see the measured bulk density. Different mixing ratios were employed by varying acetone content but keeping the mass ratio of micro-spheres to (epoxy+hardener) constant as 1 to 2 as seen in the second column of FIG. 2 Table 1. As can be seen from Table 1, the foam density decreases as the acetone content increases, and very closely approaches the bulk density of the micro-spheres which are the lower limit of the achievable foam density. In general, since the density of liquid phase is much higher than that of micro-spheres, a low foam density can be achieved by reducing the amount of liquid phase or increasing packing density of micro-spheres. The higher the buoyant force, the higher the packing is expected unless there are other factors contributing to the packing.

While the buoyant force may be a main driving force in forming the current syntactic foam, factors affecting the buoyant force may include viscosity and densities of constituent materials. The net buoyant force may be reduced in the presence of a viscous drag such that
NBF (net buoyant force)=BF (buoyant force)−viscous drag.

The viscous drag increases with increasing viscosity. However, as the acetone content increases, the viscous drag decreases due to the decrease in viscosity of liquid mixture as shown. Concurrently, the BF also decreases because of the decrease in density of liquid phase. Thus, the improvement in lowering the foam density by the addition of acetone appears to be due more to decrease in the viscous drag than that in the BF, which results in increased NBF.

Thus a new manufacturing method using a BF technique has been developed for syntactic foam. It has been demonstrated that the syntactic foam density can be lowered down to 0.08 which is very close to its micro-sphere bulk density of 0.72.

1. A method of manufacturing syntactic foam including the steps of:
providing a predetermined ratio of constituent materials including a liquid phase binder and microspheres that are naturally buoyant in that binder;
blending the constituent materials into a mixture and placing the mixture into a mould;
allowing the microspheres to float to the top of the mixture;
draining excess liquid phase binder from the mould; and
allowing the remaining liquid phase binder to set or cure between the microspheres.

2. A method as claimed in claim 1 wherein the microspheres are allowed to float to the top of the mixture until they become close packed.

3. A method as claimed in claim 2 or wherein the microspheres become close packed in a density approaching the natural microsphere bulk density.

4. A method as claimed in claim 2 wherein the step of allowing the microspheres to float to the top of the mixture until they become close packed is facilitated by selecting a liquid phase binder composition that has sufficiently low viscous drag characteristics, and sufficiently long curing time, to allow the microspheres to become close packed before the binder cures.

5. A method as claimed in claim 4 wherein the liquid phase binder composition is selected by adding a predetermined amount of diluent.

6. A method as claimed in claim 5 wherein the liquid phase binder includes an expoxy resin with hardener, and the diluent comprises acetone.

7. A method as claimed in claim 1 wherein the excess liquid phase binder is drained from the bottom of the mould.

8. A method as claimed in claim 2 wherein the liquid phase binder is drained from the bottom of the mould until the close packed microspheres reach the bottom of the mould.

9. A syntactic foam article comprising close packed microspheres bound together by a cured, originally liquid phase binder, manufactured by a method according to claim 1.
